(19) United States
(12) Patent Application Publication
(10) Pub. No.: US 2026/0054363 A1
(43) Pub. Date: Feb. 26, 2026

(54) COMBUSTION TOOL

(71) Applicant: Illinois Tool Works Inc., Glenview, IL (US)

(72) Inventors: Kevin BOUBEKEUR, Bourg-lès-Valence (FR); Olivier BAUDRAND, Beaumont-lès-Valence (FR); Christian RICORDI, Bourg-lès-Valence (FR)

(21) Appl. No.: 19/303,056

(22) Filed: Aug. 18, 2025

(30) Foreign Application Priority Data
Aug. 20, 2024 (FR) 2408974
Jul. 31, 2025 (EP) 25193266.1

(51) Int. Cl. B25C 1/18; B25C 1/16; B25C 5/13

(52) U.S. Cl. CPC B25C 1/186; B25C 1/163; B25C 5/13

(57) ABSTRACT

A combustion-powered tool comprising a body configured to receive a fuel cartridge, an electrical power supply mechanism, and an electrical device operationally connected to the electrical power supply mechanism and configured to prepare fuel in the fuel cartridge for combustion.

### PRIORITY CLAIM

This application claims priority to and the benefit of French Patent Application No. 2408974, filed Aug. 20, 2024, and European Patent Application No. 25193266.1, filed Jul. 31, 2025, the entire contents of each of which are incorporated herein by reference.

### TECHNICAL FIELD

The present disclosure generally relates to combustion-powered tools. More specifically, but not exclusively, the present disclosure relates to combustion-powered tools that use fuels that may require preparation prior to combustion.

### Technical Background

Combustion-powered nail and staple driving tools are known and normally comprise a body enclosing an internal combustion engine. The engine is powered by a pressurized fuel gas tank, which can comprise a fuel cartridge.

### SUMMARY

The present disclosure aims to provide a combustion-powered nail and/or staple driving tool comprising a body containing an internal combustion engine powered by a fuel tank, which can comprise a fuel cartridge, the fuel preferably containing no carbon, for example hydrogen or ammonia, in order to reduce and/or eliminate carbon oxide emissions. The fuel tank can be a pressurized fuel gas tank.

The present disclosure also aims to provide a more reliable and efficient combustion-powered tool.

The present disclosure relates to a combustion-powered tool comprising a fuel tank and an active device for preparing fuel in the fuel tank for combustion.

The active device can comprise an electrical device. The combustion-powered tool can comprise an electrical power supply mechanism. The electrical device can be operationally connected to the electrical power supply mechanism.

The present disclosure also relates to a combustion-powered tool comprising a fuel tank, an electrical power supply mechanism and an electrical device operationally connected to the electrical power supply mechanism for preparing fuel in the fuel tank for combustion.

The electrical device can be electrically connected to the electrical power supply mechanism.

The electrical device can be actuated to heat or activate the fuel.

The fuel can be prepared in various ways, depending on the nature of the fuel and its vapor pressure.

The tool can comprise a combustion-powered nailer, and as explained above, combustion-powered nailers typically use gaseous fuels stored in the tank as pressurized fluids. During dosing, the fuel vaporizes, which reduces the temperature of the fuel and of the surrounding components. In this case, moderate heating may be sufficient to prepare the fuel for ignition.

In some examples, the fuel tank can be removed from the body of the combustion-powered tool.

The electrical device can be associated with the fuel tank. Both can be removable from a combustion-powered tool body.

The tank can comprise a cartridge.

More specifically, in some examples, the tank comprises a cartridge, the electrical device is associated with the fuel tank and both can be removable from a body of the combustion-powered tool.

The present disclosure also relates to a fuel tank, for example a cartridge, comprising an active device for preparing fuel in the tank for combustion.

The tank can be for a combustion-powered tool as described above.

The present disclosure also relates to a fuel cartridge for a combustion-powered tool as described above, the fuel cartridge comprising an electrical device for preparing fuel in the cartridge for combustion.

The tank or the cartridge or the electrical device can comprise one or more electrical contacts. The tool can comprise one or more electrical contacts, for example to engage the electrical contact or contacts on the tank or on the cartridge or on the electrical device. At least one of the contacts can comprise spring-loaded contacts.

When the electrical device is associated with the tank or with the cartridge, it can be electrically connected to the electrical power supply mechanism by electrical contacts that engage with electrical contacts on the tool, for example when the electrical device is inserted into the tool or into a body thereof.

The electrical device can also remain mounted on or in the combustion-powered tool or its body.

More specifically, the fuel tank can comprise a cartridge that can be removed from the body of the combustion-powered tool while the electrical device remains mounted on or in the body.

The electrical device can comprise a heating device.

The heating device can comprise a heating element. The heating element can be electrically connected to the electrical power supply mechanism.

The heating device can be biased to come into thermal contact with the tank or the cartridge.

More specifically, the electrical device can comprise a heating device biased to come into thermal contact with the fuel tank.

The tool can comprise a resilient material, such as a foam material. The resilient material can bias the heating device or the heating element into thermal contact with the fuel tank or cartridge.

The electrical device can be attached to a surface of the tank or of the cartridge.

More specifically, the electrical device can comprise a heating device attached to a surface of the fuel tank.

The heating device or the heating element can comprise one or more printed circuit boards. The printed circuit board or boards can be attached to an external surface of the combustion-powered tool or to a body thereof. The heating device or the heating element can comprise a sticker or a label, which can incorporate the printed circuit board or boards. The heating element, for example the printed circuit board or boards, can be printed directly onto the surface.

The tank or the cartridge can comprise a body comprising or made of an electrically resistive material. The body can function as a heating element of the heating device.

More specifically, the electrical device can comprise a heating device, the fuel tank comprising a body comprising or made of an electrically resistive material and functioning as a heating element of the heating device.

The electrical device can be external to the fuel tank.

The electrical device can be external to the fuel cartridge.

The electrical device can be at least partly inside the fuel tank.

The electrical device can be at least partly inside the fuel cartridge.

The electrical device or the heating element can comprise a heating coil. The heating coil can be inside the tank or the cartridge. The heating coil can also be external to the tank or the cartridge.

The electrical device can comprise a vaporizer.

The vaporizer can comprise a heating element, for example a heating coil. The heating element can be inside a channel, which can be central. The channel can comprise one or more air intakes and one or more vents. The heating element can be in the channel.

The tank or the cartridge can comprise one or more wicks, which can be immersed in the fuel. Moreover, the tank or the cartridge can comprise a dip tube, which can be immersed in the fuel. The vaporizer heating element can be in the channel and/or can be fluidly connected to the wick or wicks or to the dip tube.

The vaporizer can be incorporated in or otherwise connected to the tank or to the cartridge. In this case, the intake or intakes can be at one end of the tank or of the cartridge and/or the vent or vents can be at the other end of the same tank or cartridge. The wick or wicks can be connected directly to the heating element.

When in use, air can be drawn into the channel, for example from the intake or intakes, by an air flow induction device and through the heating element. The fuel can be drawn into the heating element, for example through the wick or wicks, and vaporize in the air flow through the central channel.

In addition, the electrical device can comprise an ultrasonic actuator and/or a piezoelectric actuator. These actuators enable the fuel to be micronized in order to facilitate its vaporization and its combustion.

More specifically, the electrical device can comprise a vaporizer, for example an ultrasonic actuator and/or a piezoelectric actuator.

The electrical device can comprise a converter, which can be configured to convert the fuel, for example before it is introduced into the combustion chamber. The converter can be configured to chemically modify the fuel. The converter can be configured to separate or crack the fuel into two or more of its constituent elements.

The electrical device can be configured so that the fuel undergoes a cracking process, for example before being introduced into the combustion chamber.

More specifically, the electrical device can comprise a converter configured to separate or crack the fuel into two or more of its constituent elements.

The fuel can comprise a carbon-free fuel.

The present disclosure also relates to a combustion-powered tool for driving fasteners using a carbon-free fuel.

The present disclosure also relates to a combustion-powered tool driven or operated by a carbon-free fuel.

The combustion-powered tool can comprise a tank containing a carbon-free fuel.

The present disclosure also relates to a tank, for example a fuel cartridge, containing a carbon-free fuel.

The present disclosure also relates to a fuel cartridge for a combustion-powered tool as described above, the fuel cartridge containing a carbon-free fuel.

The carbon-free fuel can comprise hydrogen or ammonia.

The combustion-powered tool can comprise a filling module. The filling module can comprise or include the tank. The filling module can comprise or include the electrical device.

The filling module can be connected or coupled, for example removably, to a fuel tank of the combustion-powered tool, for example to fill it. The tank can comprise a cartridge. The tank can be mounted on or in the body of the combustion-powered tool.

More specifically, the combustion-powered tool can comprise a filling module including the tank and the electrical device, in which the filling module can be removably connected to a fuel cartridge mounted on or in a body of the combustion-powered tool for filling it.

The electrical power supply mechanism can comprise a battery. The power supply mechanism can comprise a power cable for connecting to a mains power source.

The electrical device can be part of a plurality of electrical devices. The plurality of electrical devices can comprise at least two devices among a heating device, a vaporizer, an evaporator, and a converter.

The plurality of electrical devices can comprise a heating device and a vaporizer. In addition or alternatively, the plurality of electrical devices can comprise an evaporator and a converter. Any other useful combination can be considered.

In some examples, two or more electrical devices are powered by the same power supply mechanism. In other examples, at least one electrical device is powered by a first power supply mechanism and at least one electrical device is powered by a second power supply mechanism.

The first power supply mechanism can comprise a power cable for connecting to a mains power source. The second power supply mechanism can comprise a battery, which can be mounted on the body of the combustion-powered appliance.

In the examples with a filling module, at least one electrical device in the filling module can be powered by an electric cable and at least one electrical device can be mounted on the body of the combustion-powered tool and powered by a battery.

The combustion-powered tool can comprise a nailer or stapler.

In order to avoid any doubt, all the features described herein also apply to any aspect of the present disclosure.

In order to avoid any ambiguity, the terms “can,” “and/or,” “for example,” and any other similar term used in the present document are to be interpreted as not limiting, such that any feature thus described is not necessarily required to be present.

### BRIEF DESCRIPTION OF THE FIGURES

Other features and advantages of the present disclosure will become apparent from the following detailed description, which will be understood in reference to the appended drawings.

FIG. 1 illustrates an example of a combustion-powered tool of one embodiment of the present disclosure.

FIG. 2 illustrates part of the fuel cartridge and its interaction with the electrical device in the combustion-powered tool in FIG. 1.

FIG. 3 illustrates an example of a combustion-powered tool of another embodiment of the present disclosure.

FIG. 4 illustrates the fuel cartridge on the combustion-powered tool in FIG. 3.

FIG. 5 illustrates another example of a fuel cartridge that can be used with the combustion-powered tool in FIG. 3.

FIG. 6 illustrates another example of a fuel cartridge that can be used with the combustion-powered tool in FIG. 3.

FIG. 7 illustrates another example of a fuel cartridge that can be used with the combustion-powered tool in FIG. 3.

FIG. 8 illustrates an example of a combustion-powered tool of another embodiment of the present disclosure.

FIG. 9 illustrates an example of a combustion-powered tool of another embodiment of the present disclosure.

FIG. 10 illustrates an example of a combustion-powered tool of another embodiment of the present disclosure.

FIG. 11 illustrates an example of a combustion-powered tool of another embodiment of the present disclosure.

FIG. 12 illustrates an example of a combustion-powered tool of another embodiment of the present disclosure.

FIG. 13 illustrates an example of a combustion-powered tool of another embodiment of the present disclosure.

### DETAILED DESCRIPTION

While the systems, devices, and methods described herein may be embodied in various forms, the drawings show and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

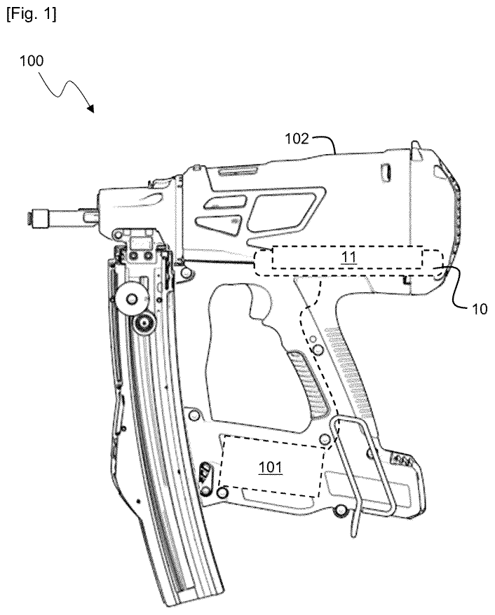

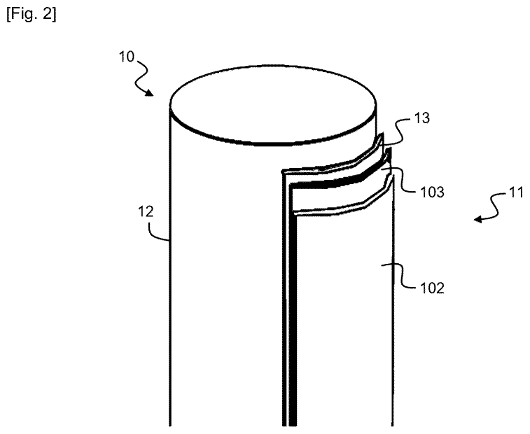

Referring to FIGS. 1 and 2, a combustion-powered tool 100 in the form of a nailer for driving nails into a substrate is shown. The combustion-powered tool 100 comprises a fuel cartridge 10, an electrical power supply mechanism 101, in this example a battery, accommodated in a body 102 of the tool 100, and an electrical device 11 electrically connected to the battery 101 for preparing fuel in the fuel cartridge 10 for combustion. In this example, the combustion-powered tool 100 has a combustion chamber (not shown) that receives the fuel from the cartridge 10, ignites the fuel to drive a piston, which in turn drives a nail into a substrate in the usual manner.

The fuel can be prepared in various ways, depending on the nature of the fuel and its vapor pressure. For example, combustion-powered nailers typically use gaseous fuels stored in the cartridge in the form of pressurized fluids. During dosing, the fuel vaporizes, which reduces the temperature of the fuel and of the surrounding components. In this case, moderate heating may be sufficient to prepare the fuel for ignition.

This heating can be achieved by heating the fuel cartridge 10, which can be done in various ways. In the case of the combustion-powered tool 100 in FIG. 1, the electrical device 11 comprises a heating device with a heating element 13. The heating device 11 is mounted in the combustion-powered tool 100 and is biased to come into thermal contact with the fuel cartridge 10.

More specifically, and as illustrated in FIG. 2, the combustion-powered tool 100 comprises a foam material 103 between the heating element 13 of the heating device 11 and an adjacent part of the combustion-powered tool 100. When the fuel cartridge 10 is mounted in the combustion-powered tool 100, the foam material 103 biases the heating element 13 into thermal contact with the fuel cartridge 10.

The fuel cartridge 10 can be removed from the body 102 of the combustion-powered tool 100, while the electrical device 11 remains mounted on the body 102. When the fuel cartridge 10 is inserted, a body 12 of the fuel cartridge 10 engages the heating element 13 and compresses the foam material 103 so that the heating element 13 is biased against the body 12.

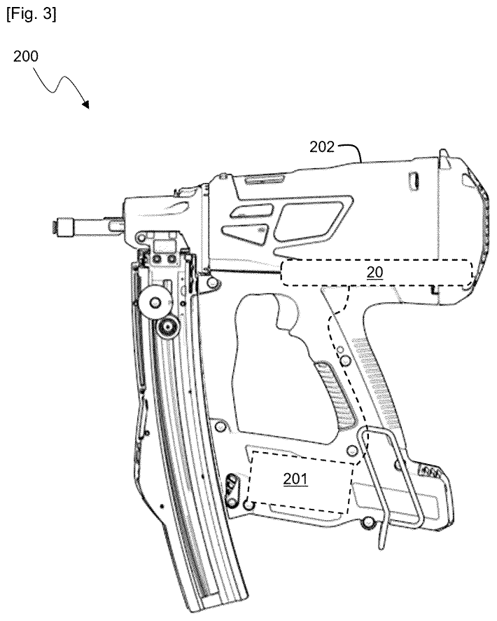

FIG. 3 shows another example of a combustion-powered tool 200 similar to the combustion-powered tool 100 in FIG. 1, where similar references represent similar features, incremented by 100. The combustion-powered tool 200 according to this example differs from the one in FIG. 1 in that the electrical device 21 is associated with the fuel cartridge 20 and both can be removed from the body 202 of the combustion-powered tool 200.

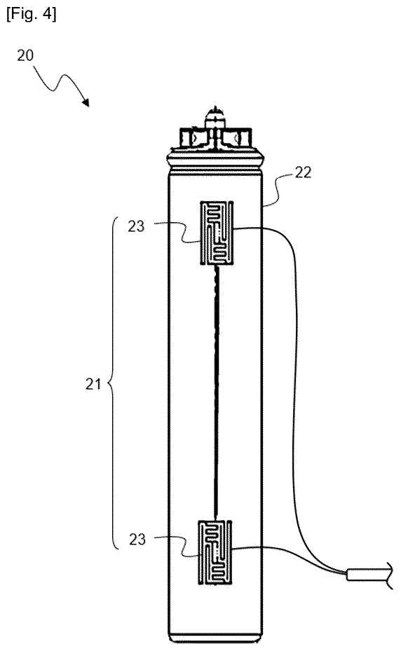

More specifically, in the example in FIG. 4, the heating element 23 comprises two spaced printed circuit boards attached to an outer surface of the body 202 and electrically connected to each other. This can be achieved using a sticker or label incorporating the printed circuit boards 23, or by printing them directly onto the surface. The person skilled in the art will understand that a single printed circuit board 23 can be provided, which can cover any proportion of the outer surface of the body 202.

The heating element 21 is electrically connected to the battery 201 by electrical contacts (not shown) on the tool 200. These electrical contacts (not shown) can engage with the corresponding electrical contacts (not shown) on the fuel cartridge 20 when the fuel cartridge is inserted into the body 202. At least one of the contacts can comprise spring-loaded contacts.

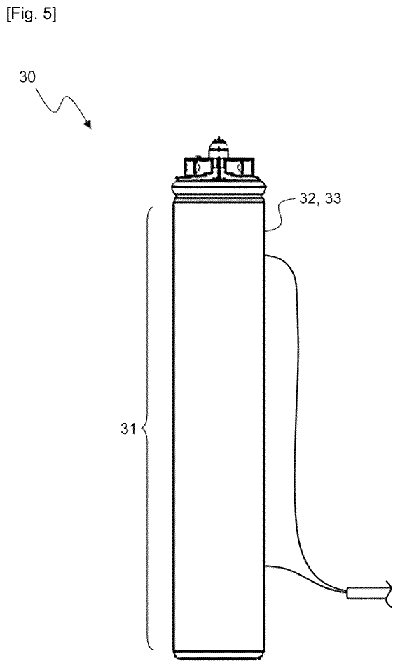

FIG. 5 shows another example of a fuel cartridge 30 similar to the fuel cartridge 20 in FIG. 4, where similar references represent similar features, incremented by 10. The fuel cartridge 30 shown in this example can be used with the combustion-powered tool 200 illustrated in FIG. 3. The fuel cartridge 30 according to this example differs from the one in FIG. 4 in that the body 32 is made of an electrically resistive material. The body 32 therefore functions as a heating element 33 of the heating device 31.

The inventors observed that only gaseous fuels with a high vaporization pressure are currently used, as they can vaporize at a relatively low temperature. This rules out potential fuels that might otherwise be suitable because they vaporize too slowly at cold temperatures, which would cause an unacceptable lag in the ignition sequence.

The inventors recognize that it would therefore be advantageous to provide a device enabling the use of fuels with lower vaporization pressure, such as fluid fuels. It can be advantageous to expand the range of fuels that can be used in combustion-powered tools, particularly fuels with a low climate impact. However, most of these fuels require an energy source (heat, kinetic energy, microwaves, ultrasound, etc.) to convert them into a combustible state. One example of this type of fuel is ammonia (NH₃), which preferably undergoes a cracking process to provide a fuel that can be used in the combustion process. Cracking ammonia makes it possible to extract hydrogen, which has excellent combustion properties, a wide flammability range, and does not generate carbon oxide emissions.

Although the examples described above can be adapted to introduce sufficient energy into the fuel contained in the cartridge 10, 20, 30 to prepare certain fuels for combustion, the inventors found that direct introduction of heat or other mechanism of activation may be necessary for certain fuels.

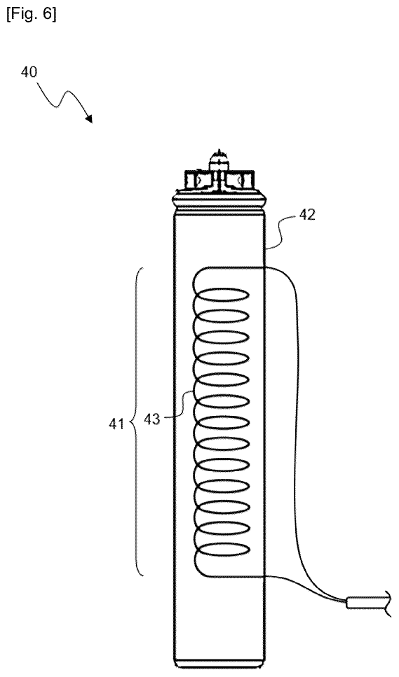

To this end, FIG. 6 shows another example of a fuel cartridge 40 similar to the fuel cartridge 20 in FIG. 4, where similar references represent similar features, incremented by 20. The fuel cartridge 40 can be used with the combustion-powered tool 200 illustrated in FIG. 3. The fuel cartridge 40 according to this example differs from the one in FIG. 4 in that the heating element 43 comprises a heating coil in this example, inside the cartridge 40.

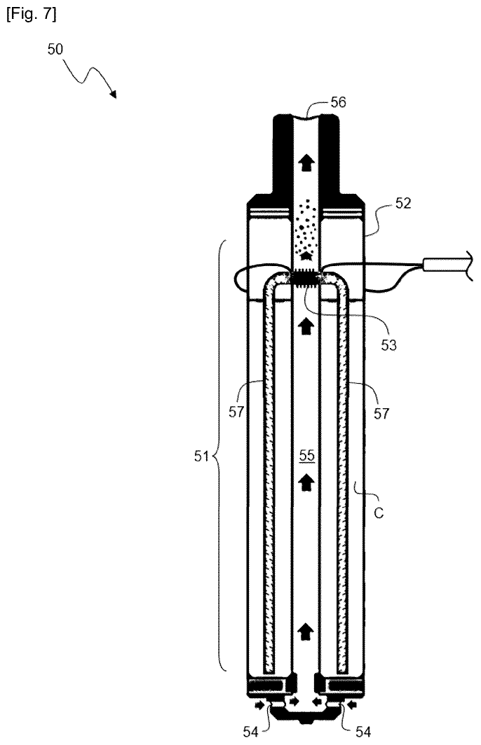

FIG. 7 shows another example of a fuel cartridge 50 similar to the fuel cartridge 40 in FIG. 6, where similar references represent similar features, incremented by 10. The fuel cartridge 50 can be used with the combustion-powered tool 200 illustrated in FIG. 3. The fuel cartridge 50 according to this example differs from the one in FIG. 6 in that the electrical device 51 comprises a vaporizer in the cartridge 50, which activates the fuel C by vaporizing it before it is introduced into the combustion chamber (not shown).

The vaporizer 51 comprises air intakes 54 at one end of the fuel cartridge 50, a central channel 55 fluidly connecting the air intakes 54 to a vent 56 at the other end of the fuel cartridge 50, and one or more wicks 57 immersed in the fuel C. The heating element 53 of the vaporizer 51 is in the central channel 55 and is fluidly connected to the wick or wicks 57.

When in use, air is drawn into the central channel 55 from the air intakes 54 by an air flow induction mechanism (not shown) and through the heating element 53. The fuel C is drawn into the heating element 53 through the wick or wicks 57 and vaporizes in the air flow through the central channel 55.

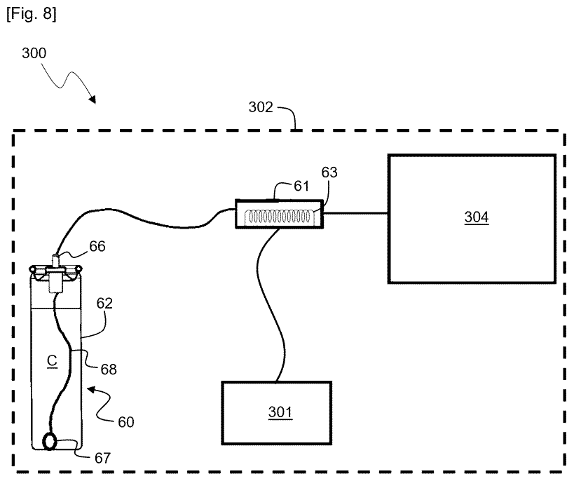

The person skilled in the art will understand that other vaporization devices can also be considered without departing from the scope of the present disclosure. Furthermore, as illustrated in FIG. 8, the vaporizer 51 does not need to be associated with the fuel cartridge 50.

More specifically, FIG. 8 shows another example of a combustion-powered tool 300 similar to the combustion-powered tool 200 in FIG. 3, where similar references represent similar features, incremented by 100. In addition, the combustion-powered tool 300 is used with a fuel cartridge 60 that is similar to the fuel cartridge 50 illustrated in FIG. 7, in which similar references represent similar features, incremented by 10. The assembly according to this example differs from the ones in FIGS. 3 and 7 in that the vaporizer 61 is external to the fuel cartridge 60. The combustion chamber 304 is also shown.

Since the fuel C in the fuel cartridge 60 is a fluid, the cartridge 60 can in this case comprise a dip tube 67 immersed in the fuel C, through which the fuel C is aspirated by a tube 68 and exits through the vent 66 to the external vaporizer 61. The vaporizer 61 operates in the same manner as the vaporizer 51 described above in connection with the fuel cartridge 50 in FIG. 7. Since the vaporizer 61 is external to the cartridge 60, the air intakes (not shown) can be upstream or downstream of the vaporizer 61, without necessarily being part of the cartridge 60.

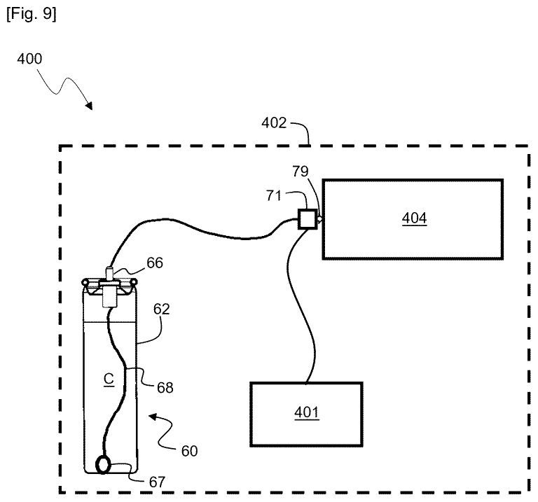

Moreover, FIG. 9 shows another example of a combustion-powered tool 400 similar to the combustion-powered tool 300 in FIG. 8, where similar references represent similar features, incremented by 100. The combustion-powered tool 400 according to this example uses the same fuel cartridge 60 as the tool 300 in FIG. 8, but differs in that the vaporizer 71 comprises an ultrasonic actuator and/or a piezoelectric actuator 79. These actuators enable the fuel to be micronized in order to facilitate its vaporization and its combustion.

It is also foreseen that the electrical device of the combustion-powered tool or of the fuel cartridge can be configured to activate or prepare fuel in a different way. For example, when the fuel is ammonia, the electrical device can be configured so that it undergoes a cracking process before its introduction into the combustion chamber.

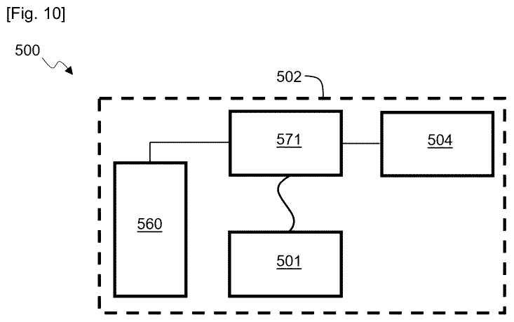

FIG. 10 shows another example of a combustion-powered tool 500 similar to the combustion-powered tool 400 in FIG. 9, where similar references represent similar features, incremented by 100. The combustion-powered tool 500 according to this example differs from the one in FIG. 9 in that the fuel cartridge 560 contains ammonia and in that the vaporizer 71 is replaced by a converter 571 to convert the ammonia.

More specifically, the convertor 571 is configured to separate or crack the ammonia into its constituent elements, in particular nitrogen and hydrogen. These components are then introduced into the combustion chamber 504 to be ignited.

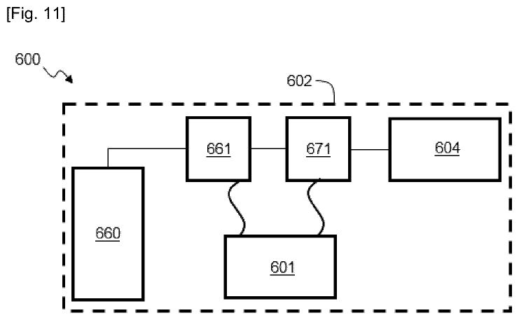

FIG. 11 shows another example of a combustion-powered tool 600 similar to the combustion-powered tool 500 in FIG. 10, where similar references represent similar features, incremented by 100. The combustion-powered tool 600 according to this example differs from the one in FIG. 10 in that it comprises an evaporator 661 upstream of the converter 671.

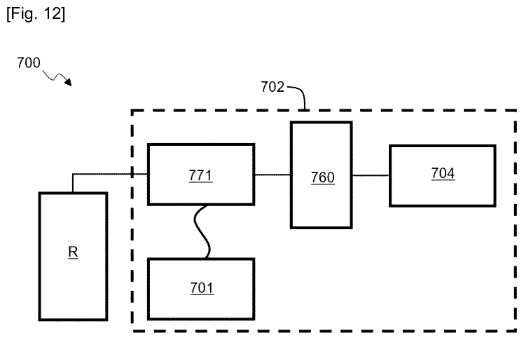

FIG. 12 shows another example of a combustion-powered tool 700 similar to the combustion-powered tool 500 in FIG. 10, where similar references represent similar features, incremented by 200. The combustion-powered tool 700 in this example differs from the one in FIG. 10 in that it comprises an external tank R containing ammonia, which is removably coupled to the converter 771, and the cartridge 760 comprises a storage buffer downstream of the converter 771 for containing the converted fuel. In this example, the cartridge 760 is periodically refilled and therefore does not need to be removable from the body 702.

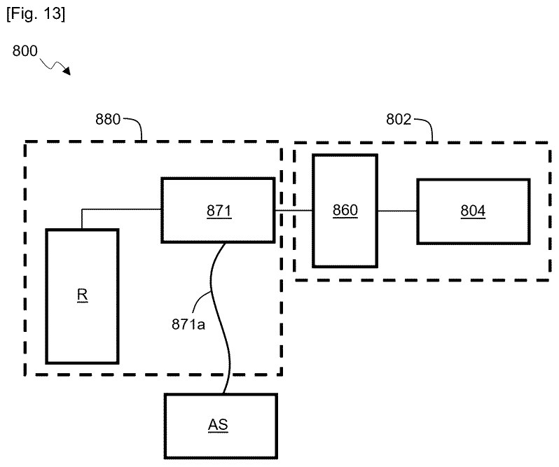

FIG. 13 shows another example of a combustion-powered tool 800 similar to the combustion-powered tool 700 in FIG. 12, where similar references represent similar features, incremented by 100. The combustion-powered tool 800 according to this example differs from the one in FIG. 12 in that it comprises a filling module 880 that includes the tank R and the converter 871.

The convertor 871 in this example comprises a power cable 871a for connecting to an AC power source. The filling module 880 is removably connected to the fuel cartridge 860 mounted in the body 802 of the combustion-powered tool 800 to fill it. As in the example in FIG. 12, the cartridge 860 is periodically refilled and therefore does not need to be removed from the body 802.

It is also foreseen that the combustion-powered tool 800 can comprise another electrical device (not shown), such as a heating device, inside the body 802 and which can be powered by a battery (not shown). Other configurations are also conceivable without departing from the scope of the present disclosure.

Although the combustion-powered tools 100, 200, 300, 400, 500, 600, 700, 800 described above are all nailers, a person skilled in the art will understand that the present disclosure can be incorporated into any other suitable combustion-powered tool. These are preferably, but not necessarily, combustion-powered tools designed to drive fasteners into a substrate, such as staplers or other similar combustion-powered tools.

The person skilled in the art will understand that the embodiments described above can vary in many ways, provided they are consistent with the scope of the claims.

### LIST OF REFERENCE NUMBERS

100 combustion-powered tool
101 battery power supply mechanism
102 combustion-powered tool body
103 foam material
10 fuel cartridge
11 electrical device in the form of a heating device
12 fuel cartridge body
13 heating element
200 combustion-powered tool
201 electrical power supply in the form of a battery
202 combustion-powered tool body
20 fuel cartridge
21 electrical device in the form of a heating device
22 fuel cartridge body
23 heating element in the form of printed circuit boards
30 fuel cartridge
31 electrical device in the form of a heating device
32 fuel cartridge body
33 heating element in the form of a body made of electrically resistive material
40 fuel cartridge
41 electrical device in the form of a heating device
42 fuel cartridge body
43 heating element in the form of heating coil
50 fuel cartridge
51 electrical device in the form of a vaporizer
52 fuel cartridge body
53 heating element
54 air intakes
55 central channel
56 vent
57 wick
C combustible
300 combustion-powered tool
301 electrical power supply in the form of a battery
302 combustion-powered tool body
304 combustion chamber
60 fuel cartridge
61 electrical device in the form of an external vaporizer
62 fuel cartridge body
63 heating element
66 vent
67 dip tube
68 tube
400 combustion-powered tool
401 electrical power supply in the form of a battery
402 combustion-powered tool body
404 combustion chamber
71 electrical device in the form of an external vaporizer
79 ultrasonic actuator and/or piezoelectric actuator
500 combustion-powered tool
501 electrical power supply in the form of a battery
502 combustion-powered tool body
504 combustion chamber
560 fuel cartridge
571 converter
600 combustion-powered tool
601 electrical power supply in the form of a battery
602 combustion-powered tool body
604 combustion chamber
660 fuel cartridge
661 evaporator
671 converter
700 combustion-powered tool
701 electrical power supply in the form of a battery
702 combustion-powered tool body
704 combustion chamber
760 fuel cartridge
771 converter
R external tank
800 combustion-powered tool
801 electrical power supply in the form of a battery
802 combustion-powered tool body
804 combustion chamber
860 fuel cartridge
871 converter
871a power cable
880 filling module
AS mains power supply

1. A combustion-powered tool comprising:
a body configured to received a fuel tank;
an electrical power supply mechanism; and
an electrical device operationally connected to the electrical power supply mechanism and configured to prepare fuel in the fuel tank for combustion.

2. The combustion-powered tool of claim 1, wherein the electrical device is actuatable to prepare the fuel by heating the fuel.

3. The combustion-powered tool of claim 1, wherein the electrical device is removable from the body.

4. The combustion-powered tool of claim 1, wherein the electrical device is engagable with the fuel tank.

5. The combustion-powered tool of claim 4, wherein the electrical device includes a heating device biased to come into thermal contact with the fuel tank.

6. The combustion-powered tool of claim 1, wherein the electrical device includes a heating device securable to a surface of the fuel tank.

7. The combustion-powered tool of claim 6, wherein the electrical device includes a heating device and the fuel tank includes an electrically resistive material that functions as a heating element of the heating device.

8. The combustion-powered tool of claim 1, wherein the electrical device is external to the fuel tank.

9. The combustion-powered tool of claim 1, wherein the electrical device is at least partly inside the fuel tank.

10. The combustion-powered tool of claim 1, wherein the electrical device includes a vaporizer.

11. The combustion-powered tool of claim 1, wherein the electrical device includes an ultrasonic actuator vaporizer.

12. The combustion-powered tool of claim 1, wherein the electrical device includes a piezoelectric actuator vaporizer.

13. The combustion-powered tool of claim 1, wherein the electrical device includes a converter configured to separate the fuel in the fuel tank into two or more of its constituent elements.

14. The combustion-powered tool of claim 13, which includes a filling module including the fuel tank and the electrical device, wherein the filling module is removably connected to a fuel cartridge mounted on or in the body.

15. The combustion-powered tool of claim 1, wherein the combustion-powered tool is a nailer or a stapler.
